(19) United States
(12) Patent Application Publication
(10) Pub. No.: US 2014/0036049 A1
(43) Pub. Date: Feb. 6, 2014

(54) Obstacle Avoidance for the Visually Impaired

(71) Applicant: Robert Henderson Miller, Scottsdale, AZ (US)

(72) Inventor: Robert Henderson Miller, Scottsdale, AZ (US)

(21) Appl. No.: 13/567,044

(22) Filed: Aug. 4, 2012

(51) Int. Cl. H04N 7/18

(52) U.S. Cl. 348/62; 348/E07.085

(57) ABSTRACT

A device for converting two images of the environment into sounds that a visually impaired person can relate to the direction and distance to objects in the physical environment. It can provide a blind person with enough information to move about and be aware of barriers.

### BACKGROUND OF THE INVENTION

There is a need for a means for a visually impaired person to be able to sense the environment and unobstructed paths to travel. The cane, seeing eye dogs and echo location have been used to help. The computer has been used to sense the environment and present information to the visually impaired. U.S. Pat. No. 5,636,038 describes “Feely Vision” that produces a touchable replica of the environment. U.S. Pat. No. 7,843,488 describes a heat image of the environment on the skin. Patent Application 20120124470 describes a method of using sound to make a picture of the environment. These and other devices require training and perception that is difficult or impossible for most people. There is a need for a device that is useful and not so difficult to master. The device of this application can supply the information from a horizontal line across the field of view as a sound with frequency and volume related to the direction and distance as it sweeps across the environment. Alternate choices by the user are the distance of a single point or multiple sweep lines at different elevations. The prototype consists of two $7 webcams and two 15 year old laptops programmed in the BASIC language. With current technology, the production device can be small, light, wearable and as fast as desired. With very little training, considerable information about the direction and distance to obstacles is available.

### SUMMARY OF THE INVENTION

This invention consists of two image acquiring devices, one or more computers, a power supply, a sound producing device, a user control device, software in the computers and wired or wireless connections which produce sounds that relate to the direction and distance of objects in the field of view

### BRIEF DESCRIPTION OF DRAWINGS

No drawings are needed to understand this invention.

### DETAILED DESCRIPTION OF THE INVENTION

The two image acquiring devices can be any equipment that can acquire two images from horizontally separated locations that cover much of the same portion of the field of view. The information is sent to one or more computers. The software will align the two images and match enough points to determine a relative distance to the objects in the field of view. The software then converts that information and sends it to the sound producing device. The intervals of sound correspond to the horizontal line or lines across the field of view, which determines the direction of objects. The frequency and volume relate to the distance of objects. The control device allows the user to control volume, number of lines and length of the lines down to a single point. There is a battery or other source of power and the devices of this invention can be connected by wire or wirelessly. This device can be augmented by optical character recognition of signs and other text converted to speech using known techniques. The preferred embodiment consists of two image capturing devices mounted on eyeglasses connected to a computer with appropriate software, an earpiece, a mobile control device and necessary batteries.

What is claimed is:

1. An apparatus for converting two images of the field of view to sounds representing the direction and distance to objects in one or more lines across the field of view or the distance to the object in the center of the field of view, all under control of the user.
